(19) United States
(12) Patent Application Publication
(10) Pub. No.: US 2021/0372627 A1
(43) Pub. Date: Dec. 2, 2021

(54) MODULAR FIREPLACE INSERT

(71) Applicant: Twin-Star International, Inc., Delray Beach, FL (US)

(72) Inventors: Nicholas Walker, Delray Beach, FL (US); Troy Sanders, Delray Beach, FL (US); Tyler Nemes, Delray Beach, FL (US)

(21) Appl. No.: 17/335,685

(22) Filed: Jun. 1, 2021

Related U.S. Application Data
(60) Provisional application No. 63/031,899, filed on May 29, 2020.

(51) Int. Cl. F24C 7/00; F21S 10/04

(52) U.S. Cl. CPC F24C 7/004; F21S 10/046

(57) ABSTRACT

Provided is an electric fireplace system for simulating the light and sound effects of real burning fuel. The system includes modular components that are configured to be packaged, shipped, stored and assembled in a deconstructed state. The electric fireplace system comprising a modular fireplace insert comprising an insert housing that defines a cavity. A simulated fuel source for simulating a fire display, the simulated fuel source includes a first housing that is configured to be positioned in the insert housing. A heater assembly for generating warm air, the heater assembly including a second housing that is configured to be positioned in the insert housing at a positioned spaced from and above the simulated fuel source within the cavity of the insert housing.

### CROSS REFERENCE TO RELATED APPLICATIONS

This application claims priority to and the benefit of U.S. Provisional Patent Application No. 63/031,899, titled MODULAR FIREPLACE INSERT and filed on May 29, 2020 which is incorporated by reference in its entirety.

### FIELD OF INVENTION

The present disclosure relates generally to electric fireplaces and components thereof and, more particularly, to electric fireplaces including a flame simulating light assembly and a heater assembly.

### BACKGROUND

Most electric fireplaces mimic the structure of a conventional wood or gas burning fireplace, i.e., viewable from one side with the electrical components hidden behind and only visible after removing the back of the electric fireplace. This electric fireplace can only be set against a wall of a room or otherwise with its backside facing a covered surface, e.g., the back of a piece of furniture with its electrical components hidden from view.

However, with traditional wood or gas burning fireplaces, the fireplace may have glass on both its front and back surface, allowing the beauty of the fire to be seen from both sides. This allows for placement in a room where both sides are visible, e.g., in a piece of furniture that is exposed on both sides or set into a wall dividing a room or rooms. This type of traditional fireplace provides enhanced physical appearance as well as heat features and meets the needs of users on both sides of the fireplace. Thus, there exists a need to have an electric fireplace that provides those same benefits to users.

### SUMMARY

In one embodiment provided is a an electric fireplace system comprising a modular fireplace insert comprising an insert housing that defines a cavity. A simulated fuel source for simulating a fire display, the simulated fuel source includes a first housing that is configured to be positioned in the insert housing. A heater assembly for generating heated air, the heater assembly including a second housing that is configured to be positioned in the insert housing. An interface device for controlling the simulated fuel source and the heater assembly. The insert housing may be a freestanding device or the insert housing may be configured to be inserted within a structure or incorporated with a structure wherein the structure includes at least one of a piece of furniture, cabinetry assembly, an opening in a wall of a building, a firebox of a traditional fireplace, and a frame. The simulated fuel source may include at least one of a set of artificial logs, artificial coal, an ember bed, an artificial grate, a background or screen, and a lighting display. The lighting display may provide visual flame effects within the insert housing. The simulated fuel source may include a lighting display that provides visual flame effects within the insert housing, the lighting display includes a light source and a reflector that includes one or more rotating spindles having projections made of reflective material. The heater assembly may include an inlet, a heat source, and an outlet, wherein the inlet is for receiving ambient air, the heat source for warming the ambient air to heated air, and an outlet for exhausting the heated air out through a front side of the inlet housing, wherein the heat source is at least one of a radiant heat source, a forced air heat source, a fan forced convection source, an infrared heat source. The second housing may be configured to be spaced from and positioned above the first housing within the cavity of the insert housing. The insert housing is modular such that it is configured to be packaged in separate components and assembled by a user to define the cavity and to support the first housing, and the second housing within the cavity. The first housing and the second housing are configured to be packaged separately from the components of the insert housing and are configured to allow a user to assemble the first housing and the second housing within the cavity of the insert housing. The components of the insert housing include a first support wall, a second support wall, a base support, a support surface, and a backing panel wherein the first housing is configured to be attached to the base support and the second housing is configured to be attached to at least one of the first support wall, the second support wall, and the support surface above the first housing. The heater assembly is configured to be removed from the insert housing while the simulated fuel source is positioned in the insert housing and the simulated fuel source is configured to be removed from the insert housing while the heater assembly is positioned in the insert housing.

In another embodiment, provided is an electric fireplace system comprising a modular fireplace insert comprising an insert housing that defines a cavity, the insert housing includes a first support wall, a second support wall, a base, a support surface, and a backing panel. A simulated fuel source for simulating a fire display, the simulated fuel source includes a first housing that is configured to be positioned in the insert housing. A heater assembly for generating warm air, the heater assembly including a second housing that is configured to be positioned in the insert housing. An interface device for controlling the simulated fuel source and the heater assembly, wherein the first housing is configured to be attached to the base support and the second housing is configured to be attached to at least one of the first support wall, the second support wall, and the support surface above the first housing within the cavity. The insert housing is modular such that it is configured to be packaged in a deconstructed state wherein separate components including the first support wall, the second support wall, the base support, the support surface, and the back panel are configured to be assembled by a user prior to attaching the first housing, and the second housing in the insert housing. The first housing and the second housing are configured to be packaged separately from the components of the insert housing. The heater assembly includes an inlet, a heat source, and an outlet, wherein the inlet is for receiving ambient air, the heat source for warming the ambient air to heated air, and an outlet is configured to exhaust the heated air out through a front side of the inlet housing. The insert housing is configured to be inserted within a structure or incorporated with a structure wherein the structure includes at least one of a piece of furniture, cabinetry assembly, an opening in a wall of a building, a firebox of a traditional fireplace, and a frame.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a perspective view of the front of an embodiment of a fireplace system.

FIG. 2 is a perspective view of the back of another embodiment of a fireplace system.

FIG. 3 is a view of the front of the fireplace insert of FIG. 2 with a heater assembly.

FIG. 4 is a perspective view of the top of a heater assembly of FIG. 3.

FIG. 5 a perspective view of the top of a heater assembly.

FIG. 6 is a perspective view of the top of a heater assembly of FIG. 3 with connection cables.

FIG. 7 is a perspective view of a portion of a simulated fuel source with connection cables.

FIG. 8 is a perspective view of a portion of a structure of the fire place system of FIG. 2.

FIG. 9 is an exploded view of a structure that may be utilized with a fireplace system.

FIG. 10 is an exploded view of another structure that may be utilized with a fireplace system.

FIG. 11 is a bottom perspective view of a portion of the simulated fuel source of FIG. 7.

FIG. 12 is a top perspective view of a portion of the simulated fuel source of FIG. 7.

FIG. 13 is a front view of a logset.

FIG. 14 is a back and bottom perspective view of the log set of FIG. 13.

FIG. 15 is a method associated with various embodiments of a fireplace system.

FIG. 16 is a block diagram of a functional fireplace system.

FIG. 17 is a front view of a stacked fireplace system.

FIG. 18A is a perspective view of a wire clip;

FIG. 18B is a plan view of angled prongs for a wire clip;

FIG. 19A is an image of portions of the insert housing being assembled;

FIG. 19B is an image of portions of the insert housing being assembled;

FIG. 19C is an image of portions of the insert housing being assembled;

FIG. 19D is an image of portions of the insert housing being assembled;

FIG. 20 is an image of portions of the insert housing being assembled;

FIG. 21 is an image of portions of the heating assembly being attached to the insert housing;

FIG. 22 is an image the simulated fuel source being attached to the insert housing;

FIG. 23 is an image of portions of the simulated fuel source being attached to the insert housing;

FIG. 24 is an image of portions of the simulated fuel source;

FIG. 25A is a schematic image of a back panel being assembled to the insert housing being assembled;

FIG. 25B is a schematic image of a back panel being assembled to the insert housing being assembled;

FIG. 25C is a schematic image of a back panel being assembled to the insert housing being assembled;

FIG. 25D is a schematic image of a back panel being assembled to the insert housing being assembled;

FIG. 26 is an image of an assembled fireplace system; and

FIG. 27 is an image of an assembled fireplace system;

The drawings are not to scale unless otherwise noted. The drawings are for the purpose of illustrating aspects and embodiments of the present technology and are not intended to limit the technology to those aspects illustrated therein. Aspects and embodiments of the present technology can be further understood with reference to the following detailed description.

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

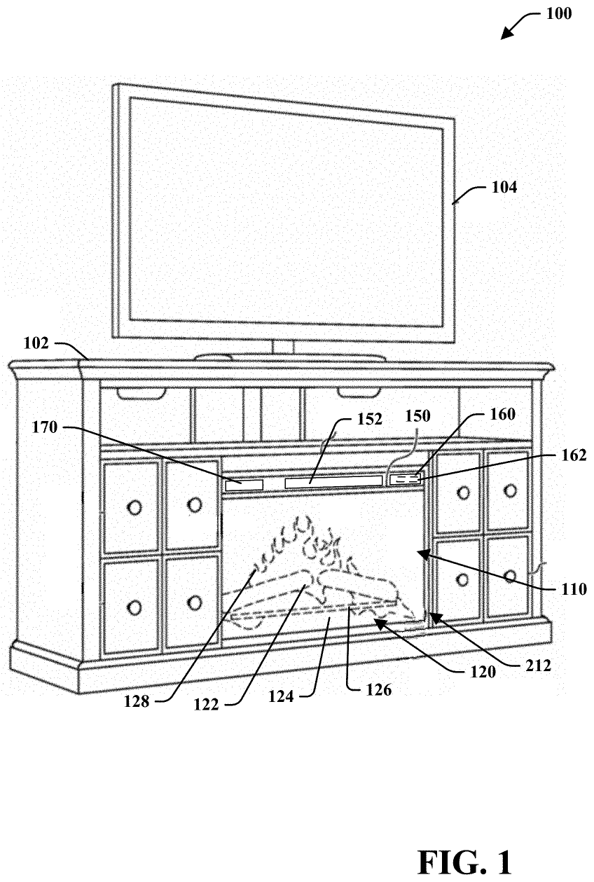

FIG. 1 illustrates an exemplary fireplace system 100. It is noted that the fireplace system 100 may primarily include a fireplace insert 110 comprising a simulated fuel source 120 and a heater assembly 150. In some embodiments, the fireplace system may be a freestanding device or may include or may be inserted within a structure 102, such as furniture (e.g., a piece of cabinetry), an opening in a wall of a building, within a firebox of a traditional fireplace, within a frame, or the like.

As used herein, the simulated fuel source 120 may include artificial logs or log set 122, coal, an ember bed 124, an artificial grate 126, a background or screen 128 (e.g., simulated brick fireplace background), or other appropriate components, including novelty fuel sources (e.g., holiday themed fuel sources, user customized fuel sources, etc.). It is noted that some or all components of a simulated fuel source may be monolithically formed or formed of separate constructions that may be assembled together, unless context suggests otherwise or warrants a particular distinction among the terms. In an example, one or more of an artificial log set, ember bed, grate, or background may be monolithically formed, such as during a molding process. Molding processes may include blow molding, injection molding, vacuum molding, or the like. It is noted that ember bed 124, log set 122, or other components may comprise semi-translucent or translucent material so as to diffuse, reflect, or otherwise allow visible light to be displayed to a user.

In some embodiments, simulated fuel source 120 may be additionally or alternatively simulated via lighting displays 104 (e.g., monitors, televisions, screens, or the like), as described here and elsewhere in this disclosure. It is further noted that the simulated fuel source may include or be coupled with a light source that may provide visual flame effects. For example, some embodiments may utilize a light source (such as one or more light emitting diodes (LEDs), an array of lights, etc.) with or without a reflector, such as a rotatable reflector (e.g., flicker rod). The light source and reflector may be disposed in various appropriate positions, such as positioned completely or partially behind, beneath, above, or beside a fuel source. It is further noted that embodiments may utilize a flame screen (e.g., screen 128, mirrors, glass, or other surfaces) that may receive or otherwise reflect light. Such flame screens may provide additional or alternative flame effects.

In examples, the light source may comprise one or more of a LED down lighting system, an LED flame light system, an LED ember bed lighting system, an LED simulated fuel source lighting system, other functional electrical fireplace components, and a chassis incorporating such parts. According to at least one example, a light source or simulated fuel source 120 may include one or more rotating spindles which may include finger-like projections comprising reflective material. The rotating spindles may be rotated by one or more motors that may be coupled to a power source, such as a batter or power mains. It is noted that various components of the simulated fuel assembly 120 may be disposed at different locations, such as in front, above, behind, to a side, or the like (relative a front view of a simulated fuel source, wherein the front view is the view at which a user may have a line of site to the simulated fuel source.) Moreover, electrical components may be connected to one or more control circuits, such as a circuit disposed on a printed circuit board. Such control circuits may include a processor including or coupled to a memory that stores computer executable instructions. The processor may execute the instructions to perform functions, such as executing a burn program, controlling a motor, controlling one or more lights or the like. It is noted that the processor may communicate with the electrical components via wireless or wired connections.

In some embodiments, the fireplace system 100 may include or be inserted within a structure 102 that comprises multiple viewable sides, such as a dual, triple, quadruple, etc. sided firebox, or the like. As such, embodiments may include one or more simulated fuel sources 120 that may simulate burning fuel viewable by a user at any of the sides.

Aspects of a simulated fuel source 120 may include attachment mechanisms, such as mechanical fasteners, chemical fasteners, slots, clips, or the like for connecting components to a structure or to each other.

The heater assembly 150 may include different types of heating elements such as radiant heat sources (e.g., heat lamps, etc.), forced air heat sources, fan forced convection, infrared, infrared with fan mode. As utilized herein, a heater assembly 150 may refer to one or more heater assemblies 150 that may be separately constructed. For instance, embodiments may utilize multiple heater assemblies 150 disposed in different housings. The heater assemblies 150 may comprise the same, similar or different heating elements (e.g., radiant, forced air, etc.). In still other examples, a heater assembly 150 may refer to a fan without heating elements. Moreover, heater assembly 150 may include an inlet that receives ambient air and an outlet 152 to force air out of the heater assembly 150, such as heated air in a desired direction. It is noted that the inlet and outlet 152 may be fluidly connected such as through ducts that may define an airflow path. The airflow path may be directed to one or more baffles that may direct forced air, absorb radiant heat, or the like. In another aspect, as the air flowing through the airflow path passes through or near heating elements or heated components (e.g., heated baffles, heated ducts, etc.) the air may be warmed such that air forced from the exhaust may provide heat.

In at least some embodiments, fireplace systems may include audio devices 170 that may receive or generate sound waves. For example, fie place systems may include speakers that may generate appropriate sounds. Such sounds may include fire crackling, logs shifting, ambient noise (e.g., animal sounds, wind, water ways, etc.), music, audiobooks, podcasts, radio programs, or the like. As another example, speakers may include or be communicatively coupled with devices that may connect to communication networks (e.g., wireless receivers, user devices, etc.). The speakers may enable playback of streaming or downloaded content stored in a local memory, in memory on a user's device, or the like. For instance, a user may stream or otherwise playback audio via the speakers of the fireplace system. It is noted that the fireplace system may include speakers disposed within the simulated fuel source 120, within a heater assembly 150, in a set-top control unit, wirelessly connected speakers (e.g., BLUETOOTH speakers, speakers on a user's device, etc.), or other speakers.

It is further noted that described fireplace systems may include an interface device 160, such as user input or output (I/O) devices, tactile buttons, touch screen or resistive buttons, microphones, pressure sensors, light sensors, cameras, keyboard, mouse (e.g., pointing device), joystick, remote controller, gaming controller, a stylus, a remote controller (e.g., wired or wireless, including user devices), or the like. Such interface devices may be localized to one component of the fireplace system (e.g., the heater assembly 150, the simulated fuel source, a portion of furniture, a separate control panel or box) and/or may be distributed across multiple components. The interface devices 160 may allow a user to control or modify parameters of a burn program, create custom programs, or manually adjust parameters.

It is noted that the interface device(s) 160 may be communicatively coupled to a control circuit. The control circuit may include or be coupled to a processor 162. The processor 162 may include or be coupled with a memory device. The memory device may be configured for storing computer executable components. Processor 162 may facilitate operation of the computer executable instructions. It is noted that system 100 may include one or more devices that may include a processor 162, such as a user device, the simulated fuel assembly 120, the heater assembly 150, set-top boxes, control panels, or the like. It is further noted that one or more devices may comprise a processor that, at least in part, controls or executes instructions for controlling the various components. For instance, a single component of system 100 may include one or more central control processors 162 that sends or distributes instructions to processors 162 contained in the other components. Accordingly, while examples may refer to a particular processor 162 executing or controlling a component, it is noted that other processors 162 disposed in other devices may control any particular component.

In an example, a user may utilize the interface device 160 on the heater assembly 150 or a user device to manually control certain parameters of the system 100. Such parameters may include turning components on/off, modifying lighting (e.g., color, speed, intensity, pattern, etc.), setting or modifying a temperature, selecting or modifying sound parameters (e.g., volume, sound source, etc.). In an example, a user may interact with the interface device 160 to select a crackling sound that may be stored on a memory storage device or streamed from a user device, server, or the like. The processor 162 may generate instructions to an audio device 170 to select or playback the appropriate sound. It is noted that the user may select a particular light pattern or the processor 162 may automatically select a light pattern to match the selected sound. In other embodiments the user may select other parameters and the processor 162 may automatically select parameters to match the user selection (e.g., light intensity, color, heat, sound, etc.). Moreover, processor 162 may control the various components such as control parameters of individual LEDs, blower speeds, or the like.

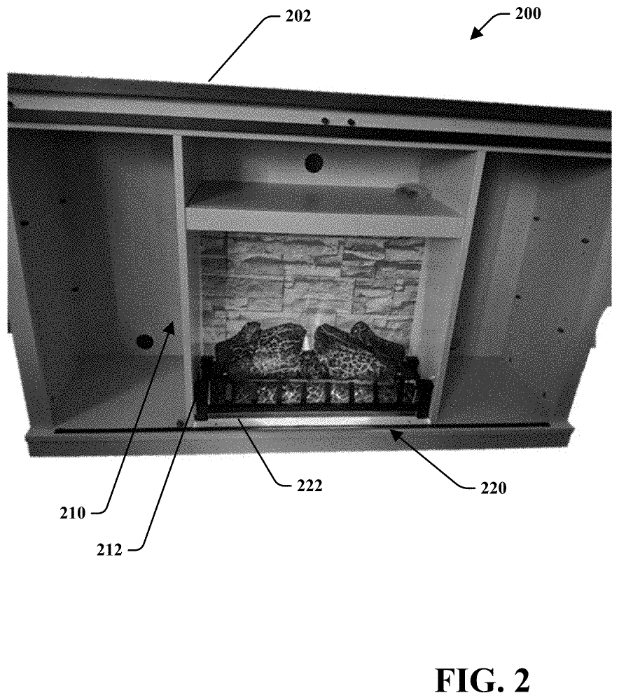

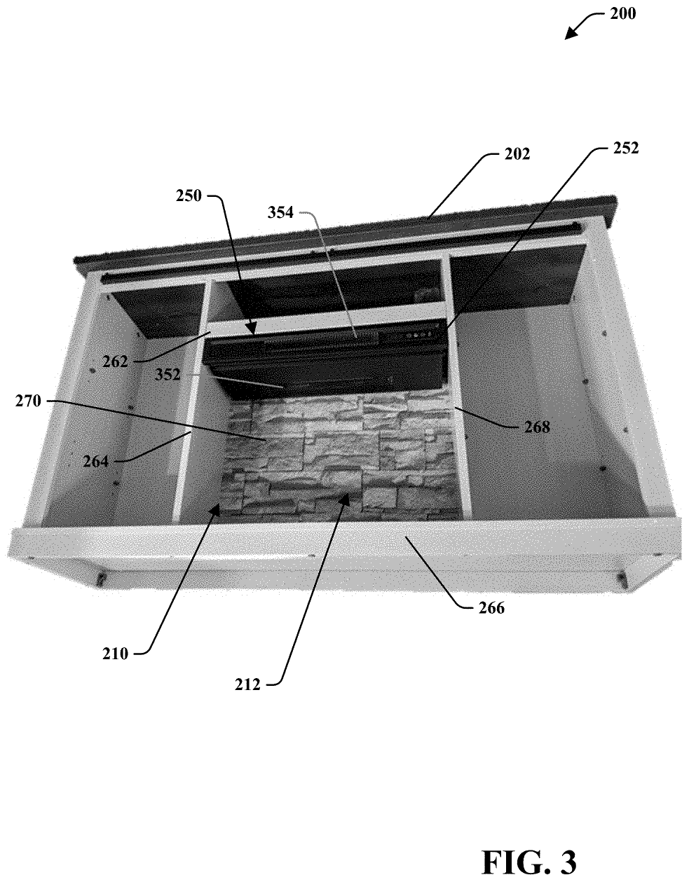

Referring now to FIGS. 2-3 there illustrated is a fireplace system 200. Fireplace system 200 may primarily include a fireplace insert 210 comprising an insert housing 212 for supporting a simulated fuel source 220 and a heater assembly 250 therein. The fireplace insert 210 and its insert housing 212 may be insertable or otherwise assembled within a frame or structure 202. FIG. 2 illustrates the simulated fuel source 220 inserted within the structure 202 without the heater assembly 250. FIG. 3 illustrates the fireplace system 200 within an inserted heater assembly 250 and without the simulated fuel source 220. The insert housing 212 may have various components that once assembled, define a cavity for receiving and supporting the simulated fuel source 220 and the heater assembly 250. The components of the insert housing 212 may be “deconstructed” when packaged or stored and broken down to allow for compack arrangement for ease of transport and storage. As such, the simulated fuel source 220 may be consolidated in its own modular housing and the heater assembly 250 may likewise be consolidated in its own modular housing. The various components of the fireplace system 200

It is noted that like named components of various systems described herein may comprise similar or identical aspects and/or functionality unless context suggests otherwise or warrants a particular distinction among such components. For example, fireplace system 200 may comprise the same, similar, or different components as system 100, such as a simulated fuel source, heater assembly, structure, audio device, and interface devices.

Conventional wisdom teaches that such fireplace inserts should be constructed so that all components are retained in a single housing or insert housing. Thus, all electronic and mechanical components are retained in one housing. Disclosed embodiments break from this conventional wisdom in this and other aspects that will be apparent herein. As an example, fireplace system 200 may comprise a modular fireplace insert 210 that may provide for flexibility in modifying a fireplace system, flexibility in creating embodiments with a wide variety of features, ease of manufacturing, economic advantages, packaging, transporting, storing, increased ability to modify components for assembly within various structures having different dimensional requirements. For instance, embodiments may include the simulated fuel source 220 comprising a first housing (which may house some or all components of the simulated fuel source 220) and the heater assembly 250 comprising a second housing (which may house some or all components of the heater assembly 250). This may allow the heater assembly 250, as well as other components, to comprise high voltage parts that require an increased level of safety testing and certification, relative lower voltage parts, such as the simulated fuel source or other lighting, to be tested separate from lighting. The relatively low voltage lighting may be generally benign such that it requires less safety testing or different, if any, certification. Splitting these assemblies may allow a single heater assembly 250 to be utilized with various different simulated fuel sources, without having to re-engineer the heater assembly 250. It is noted that such embodiments may thus include a defined connection and control protocols which provide a series of rules or instructions such that control operations may interface with various components as described herein and elsewhere in this disclosure.

As shown in FIG. 3, the heater assembly 250 may be positioned above a simulated fuel source 220 within the insert housing 212, such as attached to a wall or support surface 262. It is further noted that the heater assembly 250 may additionally or alternatively be mounted on other surfaces within the insert housing 212. Notably, the insert housing 212 may include a plurality of components that may be configured separately from the structure 202. These components may include a first support wall 264, an opposite second support wall 268, a base support 266, support surface 262, and back panel 270. Moreover, heater assembly 250 may be mounted in other areas of a structure, such as in separate cabinets or drawers than the simulated fuel source 220. As such, the heater assembly 250 may be located at various positions relative the simulated fuel source 220, such as above, below, to a side, behind, or the like, where the relative positions are with reference to the fireplace system 200 as viewed from a front side (shown in FIGS. 2-3.)

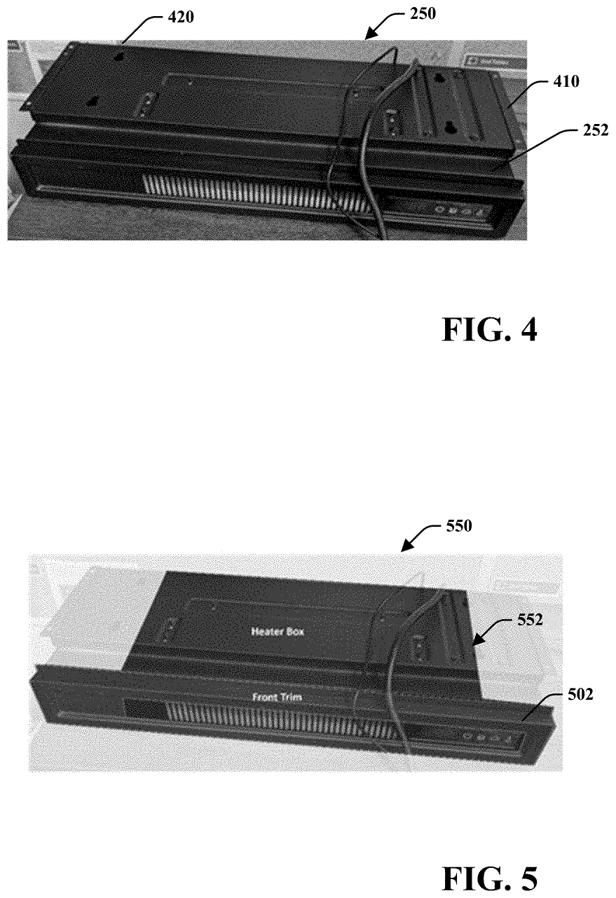

Turning to FIG. 4, with reference to the other figures, the heater assembly 250 is shown in a detached state, wherein the heater assembly 250 is not mounted or otherwise attached to the insert housing 212 or the structure 202. As shown, the heater assembly 250 may include a mounting hardware or mechanisms such as a ratchetting mechanism, magnet, bayonet-type lock, rails, fasteners, or the like that may facilitate attaching the housing 252 to the insert housing 212 or structure 202. For instance, the housing 252 may include one or more (e.g., 1, 2, 3, 4, etc.) slots or openings 420. The openings 420 may comprise keyhole slots for mounting the housing 252 to corresponding male members, such as pre-installed pegs in the structure 202. It is noted that the housing 252 may include male members, while the structure includes female members. Additionally or alternatively, the housing 252 may include other mechanisms such as rails or brackets 410 that may slide into corresponding receiving members, such as grooves in the insert housing 212 or structure 202. It is noted that the mounting mechanisms may be disposed at various sides of the housing 252, such as a front, back, top, bottom, left or right side of the housing 252. The location of the mounting mechanisms may allow for attaching the housing 252 to a desired location of the structure 202. In some embodiments, the mounting mechanisms or placement therefore may be selected by a user such that a user may operatively attach the housing 252 in a desired location.

While the heater assembly 250 may be mounted in any desired location, the heater assembly 250 is generally positioned such that an inlet 352 may receive ambient air while an outlet 354 generally expels or forces air towards a front of the inlet housing 212 and fireplace system 200, where the front of the fireplace system 200 refers to the side viewable in FIGS. 2 and 3, which is the side at which the simulated fireplace assembly 220 is viewable. In some embodiments, the outlet 354 may direct forced air in other locations in addition to or as an alternative to the front of the fireplace system 200. For instance, the flexibility of positioning the heater assembly 250 allows the heater assembly 250 to direct forced air from a top, side, or back of a fire place system 200. In at least one example, the heater assembly 250 may include a plurality of outlets that allow forced air to be blown from or at various locations. Generally, such locations allow heat to be directed away from the fireplace system 200 and into an ambient environment.

It is noted that some embodiments may include a plurality of heater assemblies 250 that may comprise the same, similar, or different heating element types. This may allow a single fireplace system 200 to be installed in large areas, such as in large rooms, multi-sided fireboxes, in commercial environments, or the like. Such heater assemblies 250 may be controlled by a single control unit (e.g., such as at an administrative control box), at their individual locations, or the like.

Turning now to FIG. 5, there illustrated is a modular heater assembly 550 that may include some or all of the aspects described with reference to the various other figures. For instance, the heater assembly 550 may include a housing 552 and a face plate 502 or trim portion. It is noted that the housing 552 may include mounting mechanism as described here and elsewhere in this disclosure.

The housing 552 may contain operative elements, such as heating elements, a blow motor, baffles, and the like. The housing 552 may be generally compact or reduced in size such that it may be positionable in different structures or otherwise disposed in various locations. It is further noted that the housing 552 may be attachable to various different face plates 502. For instance, the housing 552 may be attachable to different face plates 502 of different dimensions (e.g., width, height, depth, etc.), ornamental design, or the like. In an example, the face plates 502 may be interchangeable using mechanical or chemical fasteners.

As such, the heater assembly 550 may be utilized in a variety of different structures without having to redesign the heater assembly 550, obtain new certifications, or the like. In an example, the heater assembly 550 may be utilized in insert housings 212 for a fireplace system of different sizes, such as q inch fire place, where q is a number (e.g., 18″, 23″, 26″, 33″, 42″, etc.).

In still another method of the invention, the appearance of the heater assembly 250/550 may be altered by connecting, interchanging, and removing one or more face plates 502 with the heater assembly 250/550. The face plates can be decorative in nature and can be easily connected to and removed from the front portion of the fireplace housing using conventional fastening means, e.g., via attachment points.

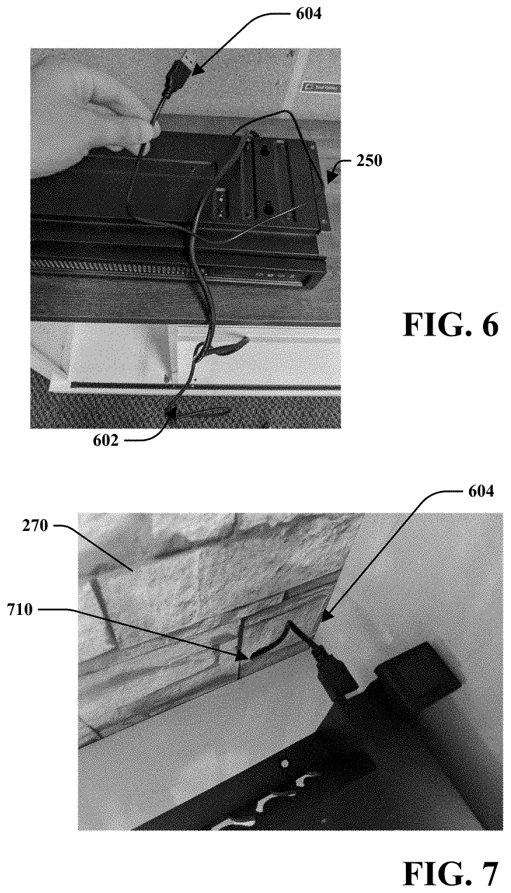

In examples, the heater assembly 250/550 may include electronic controls, such as a control circuit that converts AC power into DC power to power various components. For instance, the heater assembly 250/550 may include a connection to power mains (e.g., electrical outlet, etc.). The heater assembly 250/550 may include circuitry to apply power to a simulated fuel source. It is further noted that the circuitry may generate and supply control signals to the simulated fuel source to control parameters, such as a color of light, intensity, speed, etc. For instance, as shown in FIGS. 6-7, the heater assembly 250 may include a power cable 602 for connection to a power source and a communications cable 604 for connecting to other devices, such as simulated fuel source 220 (or other devices, such as a computer). While a universal serial bus (USB) cable is shown passing through an opening 710 of the structure 202, it is noted that other types of cables may be utilized. Moreover, embodiments may utilize wireless communication, such as BLUETOOTH, Wi-Fi, or the like. As such, the simulated fuel source 220 may connect to a power source via a wired connection and to the heater assembly 250 via wireless connection.

As described here and elsewhere in this specification, it is noted that the control circuitry may be disposed completely or partially in other devices, such as within the simulated fuel source 220, in a separate control unit, in a user device, or the like. It is noted, however, that supplying the control circuitry within the heater assembly 250 may allow for increased ability to utilize various different components with a heater assembly 250 without modifying the heater assembly 250 or requiring certification.

It is further noted that the described embodiments may allow for different combinations of heater assemblies and simulated fuel sources. For instance, different types of heater assemblies incorporating different heating technologies may be utilized with different types of simulated fuel sources, including different simulated fireplaces, simulated torches, simulated gas lamps, etc. The modularity disclosed herein provides great flexibility to swap out different heating technologies when a consumer purchases a unit or at any other time. In some examples, a system 100 may be packed and sold with multiple different types of simulated fuel sources 220 such that a user may attach or replace different simulated fuel sources 220 as they desire.

It is further noted that embodiments may allow for retrofitting by providing components that are both backwards and forwards compatible. In an example, a user may purchase a system 200. After some time, a user may desire to obtain a new model simulated fuel source 220 or heater assembly 250 while retaining their current insert housing 212 or structure 202. The user may be able to purchase a desired component and easily replace prior components with the new component. It is noted that embodiments may include a particular communication protocol that may allow a control circuit to identify a make and model of a new component, receive updated programming from a new component or other source (e.g., a user device, direct communications connection), or the like.

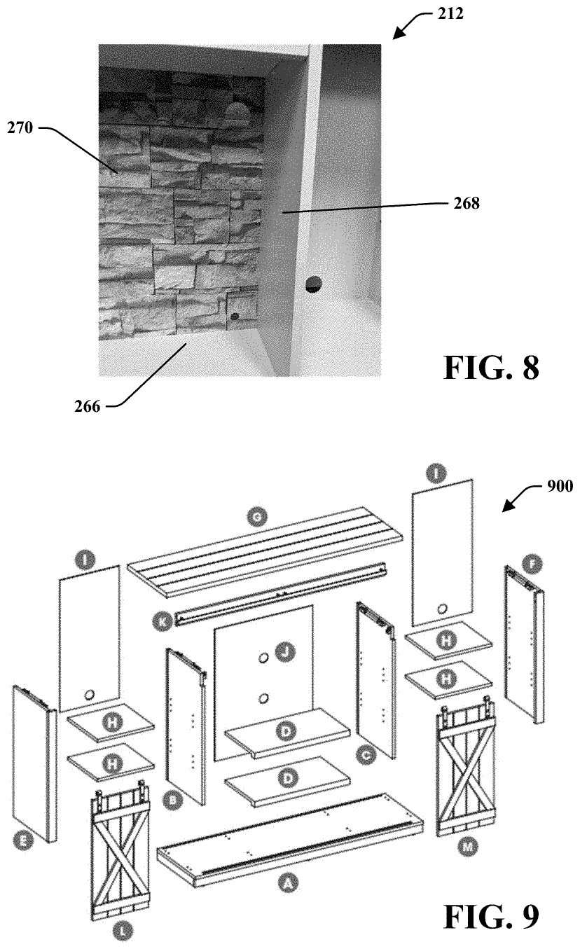

Turning now to FIGS. 8-10, there illustrated are structures 202, 900, and 1000. It is noted that embodiments disclosed herein may include various different types of structures that may incorporate or be coupled with different types of heater assemblies or simulated fuel sources, as described here and elsewhere in the specification. It is further noted that a user may build their own structure, modify existing structures, or the like.

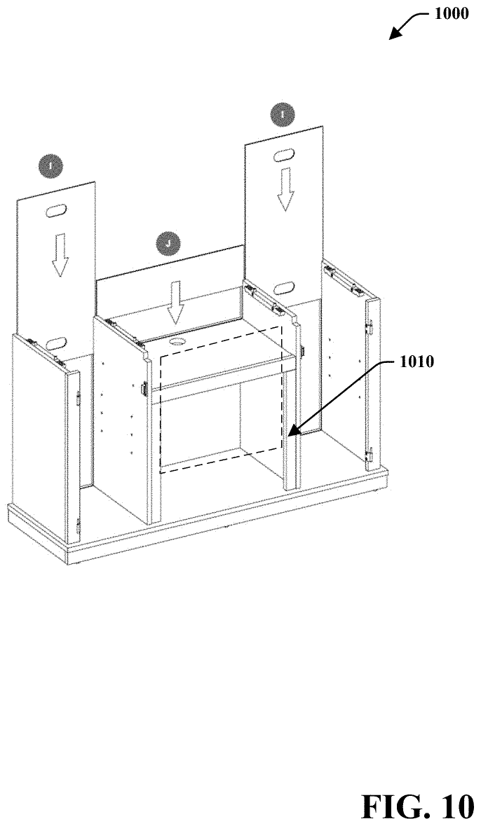

FIG. 8 provides an enlarged view of a portion of insert housing 212 within the structure 202. It is noted that portions of the structure 202 may take the place of or otherwise remove the need for some traditional components of electronic fireplaces. For instance, the surfaces of the base support 266, wall support 268, and back panel 270, and other surfaces may act as reflective surfaces or flame screens as described herein. Moreover, as components (e.g., heater assemblies and simulated fuel sources) may be positioned in any desired location, various other surfaces of structures 202, 900, and 1000 may act as flame screens or reflective surfaces. It is further noted, as shown in FIG. 10, that a front panel 1010 may be disposed to prevent access to the simulated fuel source. In an example, the front panel 1010 may comprise a clear wall (e.g., glass, plastic, etc.), a screen or curtain (e.g., metal, plastic, etc.) or other surface. In assembly the front panel 1010 can slot into a wood support, be attached with fasteners, dowels, magnets, pins, or the log.

According to at least one embodiment, the back panel 270 may comprise a back panel of the fireplace insert 210 or a flame screen that light projects onto. The back panel 270 may be attached to or a part of the insert housing 212 which may be assembled with the structure 202 such that a separate flame screen is not required. For instance, the back panel 270 and flame screen may be wood, plastic, wood based fiber board product, and laminated with veneer or furniture style laminate finishes (e.g., stone, brick, etc.). In some embodiments, other supports or side panels may additionally or alternatively include a decorative finish like brick or stone, solid colors, or designed to match a piece of furniture.

Moreover, such structures 202, 900, and 1000 may comprise routing to allow for cables to pass generally unseen by a user. Such routing may include apertures positioned in locations which are not visible when a system is fully assembled.

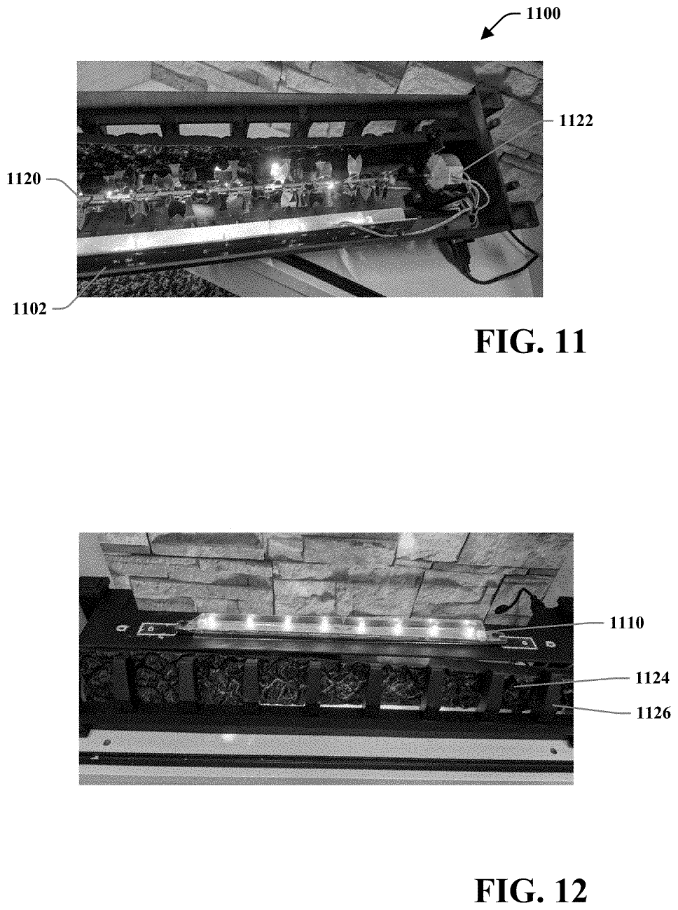

Turning now to FIGS. 11-14, there illustrated is a simulated fuel source 1100. The simulated fuel source 1100 may include some or all aspects as described with reference to the other figures. FIGS. 11-12 illustrate an ember bed 1124, a grate 1126, one or more lights 1110, a rotating device 1120 (which may be coupled to or include a motor 1122), and a control board 1102, which may include control circuitry, a processor, wireless communication devices, and the like, as described here and elsewhere in this disclosure.

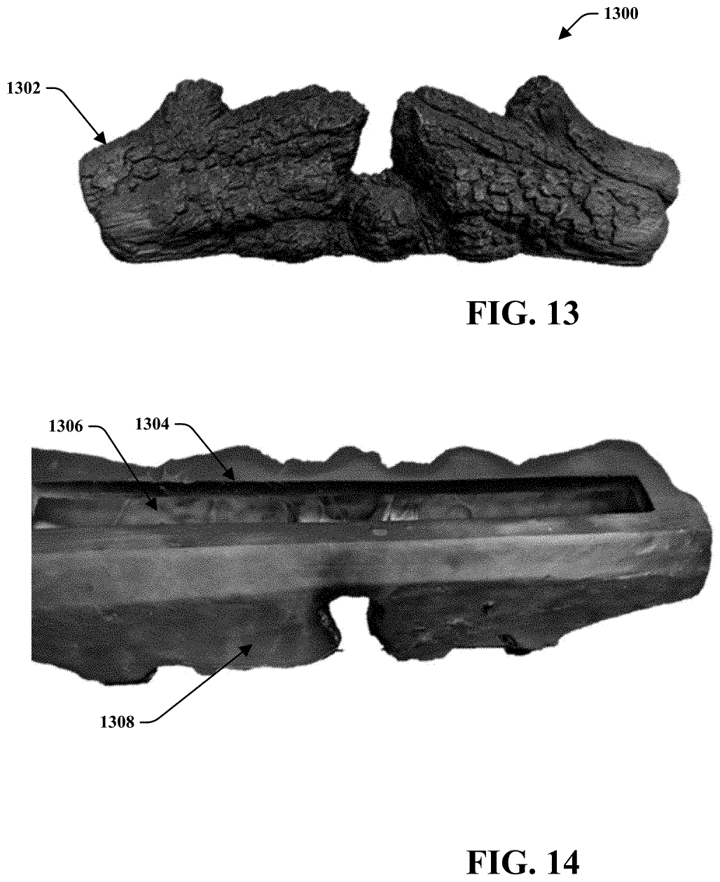

FIGS. 13-14 illustrate a log set 1300 that may be attached to one or more of the components shown in FIGS. 11-12. For instance, the log set 1300 may comprise a body including a surface 1302 that may simulate one or more logs, such as charred logs. The log set 1300 may include an opening 1304 that may lead into a cavity 1306. A portion of the grate 1126 or ember bed 1124 may be attached to the log set 1300 such that some or all of the light generated or reflected by the components shown in FIGS. 11-12 is directed towards or into the cavity 1306. In other examples, the lights 1110 may be contained within the cavity 1306 such that light reflects off the rotating device 1120 and is directed out of the back 1308 of the log set 1300. The back 1308 may be open, may include flame shaped apertures, or the like. The light or simulated flames may be allowed to project onto a screen such as described here and elsewhere in this disclosure. For instance, a flame screen may comprise fiberboard material that may be included within a structure or may be a disparate insert. Light, additionally or alternatively, may be reflected towards the surface 1302, towards the ember bed 1124 or towards other components.

It is noted that embodiments may include other or different simulated fuel sources, including other or different light sources and the like such as described with reference to FIG. 1 and the various other figures.

According to various embodiments, a heater assembly or simulated fuel source may include or communicate with one or more sensors. The sensors may monitor heating, positioning of doors, objects blocking heating, or the like. The sensors may include proximity sensors, motion sensors, light sensors, tactile or mechanical sensors, reed switches, RFID devices (such as NFC devices), or the like. Such sensors may be integrated within the heater assembly, simulated fuel source, a structure, or may be removably attachable thereto. In an example, the heater assembly may include a sensor that monitors or detects when an object is or may be blocking an outlet of the heater. In such instance, the heater assembly may shut off heating so as to prevent overheating. In some examples, the heater assembly may detect an object utilizing an IR sensor. In other examples, portions of a structure may include actuators, such as a mechanical actuator, magnet for activating a reed switch, inductive coil, or the like. In other examples, a heater assembly may be positioned such that its outlet will not be covered by a closed door or drawer. This may allow a heater assembly to maintain operation while a simulated fuel source is blocked or hidden from view.

In at least one embodiment, multiple or different simulated fuel sources may be located or positioned in different portions of a structure. For instance, embodiments may include simulated gas lighting, candles, or other simulated fuel that may be positioned in or on a structure, as such embodiments may not include simulated fire places. Such multiple or different simulated fuel sources may be communicatively coupled to a heater assembly or control component.

Moreover, simulated fuel sources may be positioned at different locations on a structure, may be movable, retractable, or otherwise repositionable according to a user's preference.

While the embodiments described above feature a reflector-containing rotating spindle to reflect light from flame light LEDs onto a projection screen, in other embodiments within the invention, the appearance of a flame can also be simulated using a spindleless device. For example, to create the appearance of flames, a ribbon fire system might be used wherein ribbons are placed between the flame light source and the projection screen and air is blown onto the ribbons to make them move in a side-to-side manner such that the light transmitted through the ribbons mimic the look of real flames on the projection screen. As another example, flames can be simulated in an electric fireplace lacking a rotating spindle using CPU-controlled flame light LEDs positioned behind a flame cutout panel which is behind a projection screen. In one such embodiment, the flame light LEDs are arranged in strips or a panel positioned roughly parallel to the flame cutout panel. Rather than using the mechanical movement of a reflective spindle to create a flame motion effect, this effect is generated directly using a program that causes the CPU to activate the flame light LEDs in a sequence that creates the appearance of a moving flame on the projection screen. Use of a multiple flame light LED system allows this to work because, unlike conventional incandescent lighting, each of the individual LEDs can be controlled with the exacting precision in a pre-determined sequence that results in an image of a realistic moving flame on the projection screen.

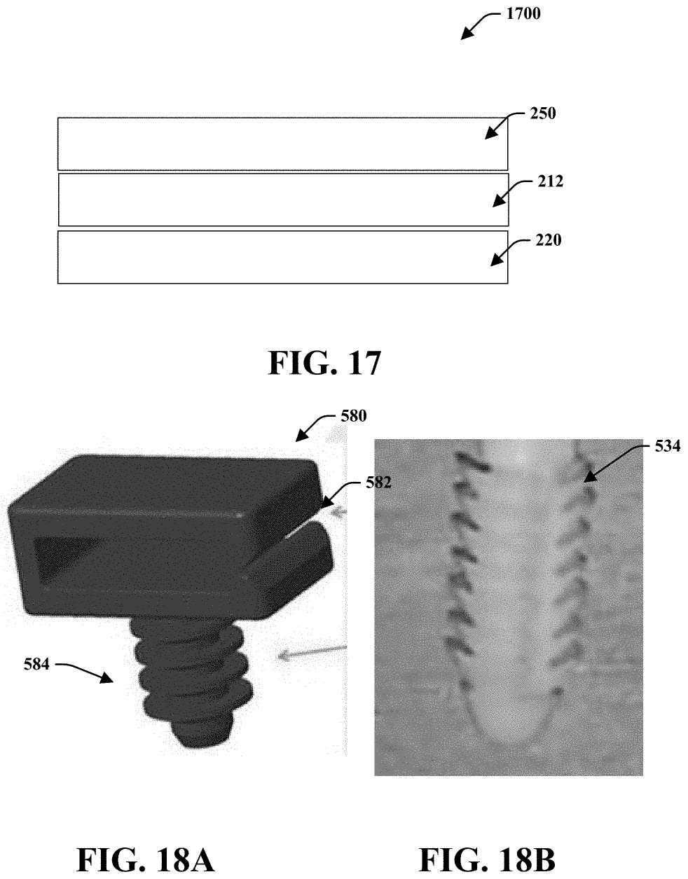

It is noted that the various components of structures 202, 900, and 1000 may be purchased and shipped in a deconstructed state. With reference to FIG. 17, there is an exemplary stacked orientation 1700 wherein the heater assembly 250, insert housing components 212, and simulated fuel source 220 may be deconstructed to be shipped in a stacked or compact package. This saves space for retailers and consumers during shipman, storage, and transport of these systems. It is noted that traditional fireplace inserts require large housings, typically of metal, which include walls, flame screens, wiring, and other elements. Such traditional fireplace inserts may add increased height and may prevent stacking for shipping. Described embodiments solve this need. While examples refer to a deconstructed state, it is noted that some components may come pre-assembled. For instance, one or more of the heater assembly 250 or simulated fuel source 220 may be attached to a support surface of the structure 202. The heater assembly and simulated fuel source may be packaged in their own housing that is in a pre-assembled state wherein all that is needed for a user to assemble the system is to arrange the housings within the cavity of the insert housing and plug in each component to respective wiring. This may reduce steps for a user, reduce error, and at the same time still enable the stacked orientation 1700 for shipping.

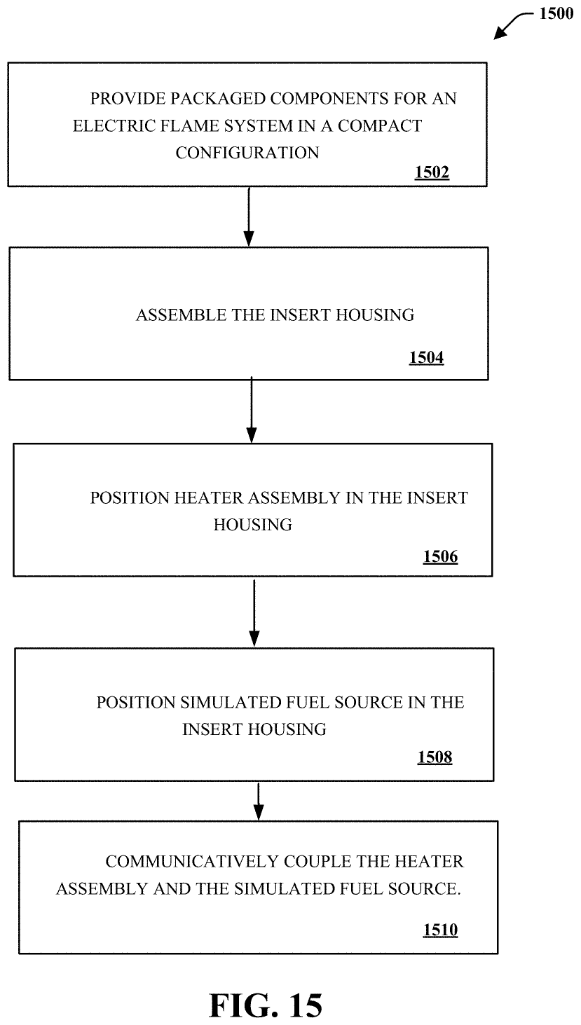

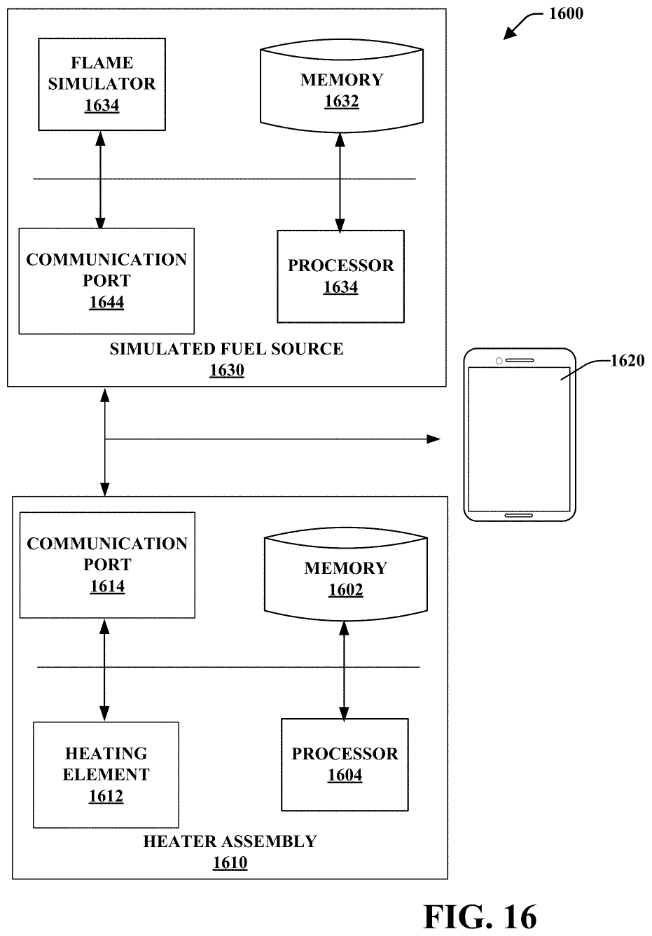

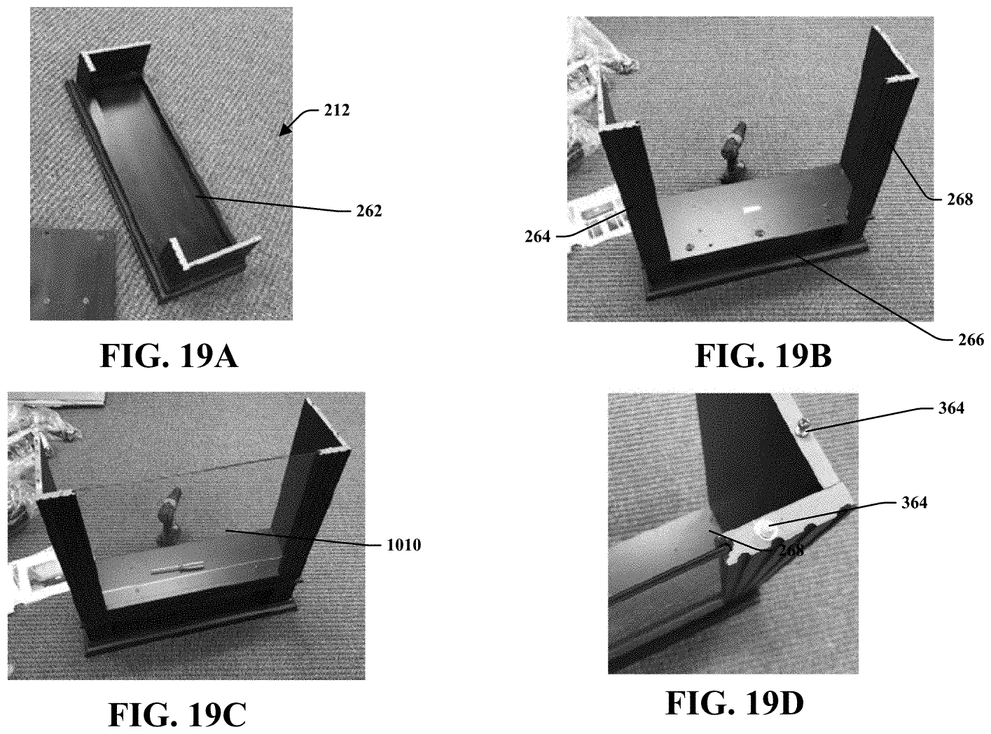

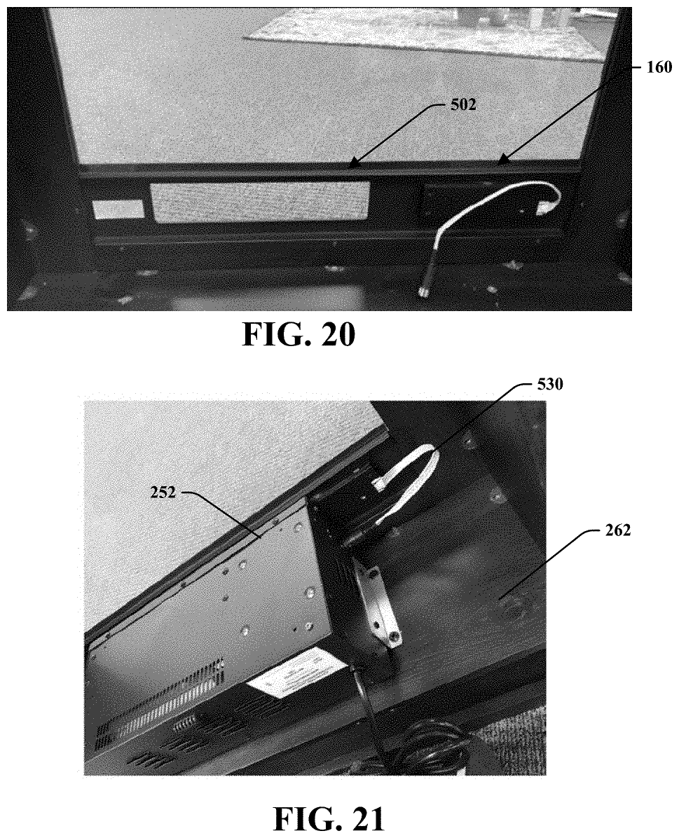

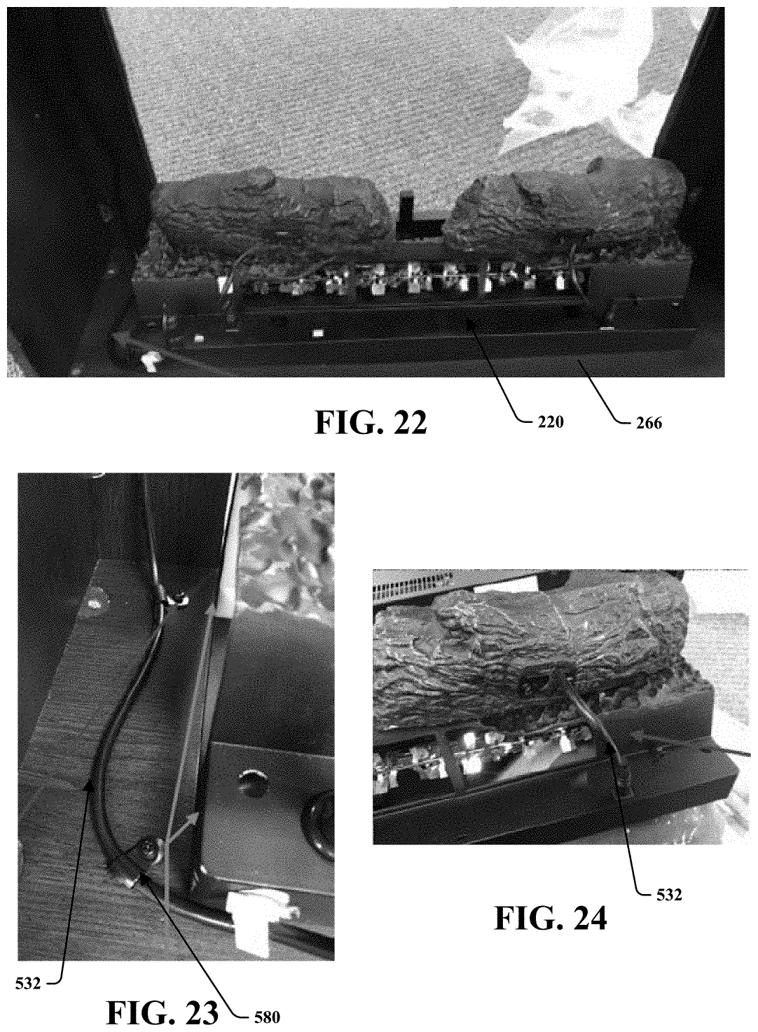

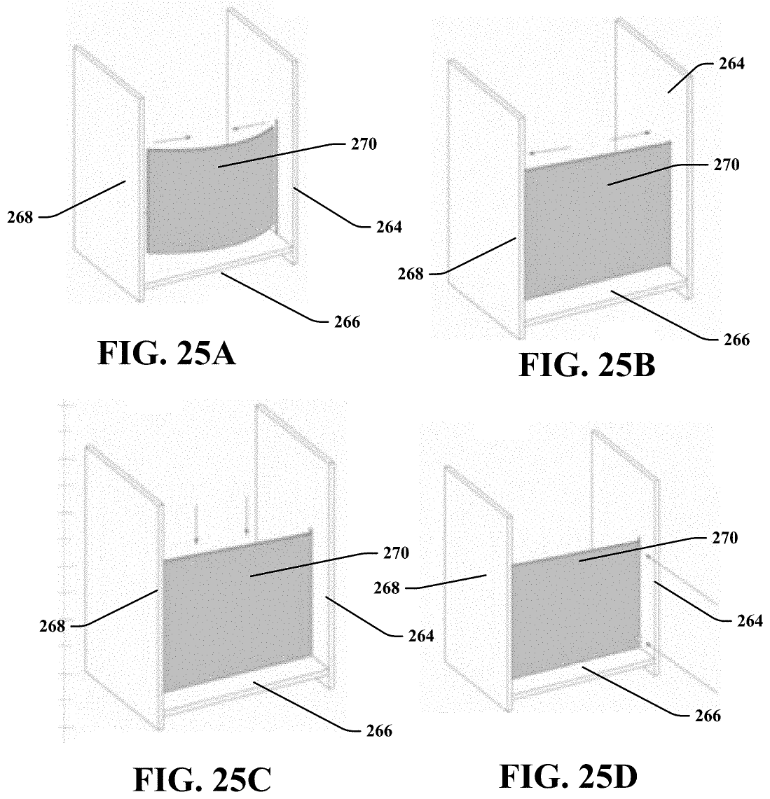

With reference to FIGS. 15, 19A-19D, 20-23, and 24A-24D, the system 100 is further described as to how its deconstructed components may be shipped and packaged in a compact configuration 1700 where the components of the insert housing 212 are separate and the housing for the heating source 250 and the housing for the simulating flame element are pre-assembled to be assembled into the cavity of the insert housing 212. Notably, the steps of assembling the electric flame system 100 of the instant disclosure includes the steps of providing a packaged components in a compact configuration, (i.e., deconstructed state) 1502. The insert housing 212 is then assembled or at least partially assembled 1504. This includes assembling the first support wall 264 and second support wall 268 to the support surface 262 (i.e., top portion) and assembling the front panel 1010 to the support walls. Notably, various fasteners may be used to complete the assembly such as bolts and screws but also Rafix fasteners 364 may be utilized and this discloser is not limiting to the type of fasteners or connectors used in this regard. Turning to FIGS. 20-23, the front panel 1010 also may also include the interface device 160 which may be assembled to a front of the inset housing 22 along with the face plate 502 for the heater assembly 250. The heater assembly 250 may be fastened to the support surface 262 and attached to the face plate 502 while also a wire 530 is attached to connect the interface device 160 to the heater assembly 250. Notably, the attachment is made along a side of the heater device and that the wire 530 is relatively short to hide the wire from view through the front panel 1010. As such, the heater assembly is positioned in the insert housing per step 1506.

Optionally, the simulated fuel source 220 can be placed within the insert housing before or after the heat assembly 250. Step 1508 is performed by fastening the housing of the simulated fuel source to the base 266 of the insert housing 212. A wire 532 from the simulated fuel source may be routed to communicate with the heat assembly 250. Wire clips (See FIGS. 18A and 18B) may be coupled to the wire 532 to maintain the wire 532 along the surface of the insert housing and generally prevent it from being viewable through the front panel. Clips 580 may have a V shape clip mouth 582 to allow wires to be easily attached to the clip or removed from the clip. It may also include a threaded member 584 with conventional threads for rotatable attachment within an aperture or may include a plurality of angled prongs 534 to allow for the clip to be press fit therein as illustrated by FIG. 18B. The angled prongs 534 assist with attaching the clips to the surfaces within the insert housing when there is minimal space and rotating the clip with threads may not be desired.

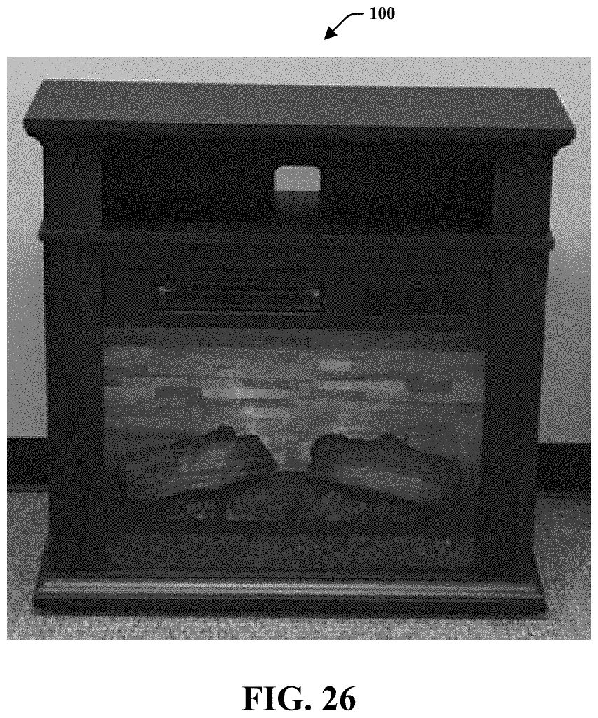

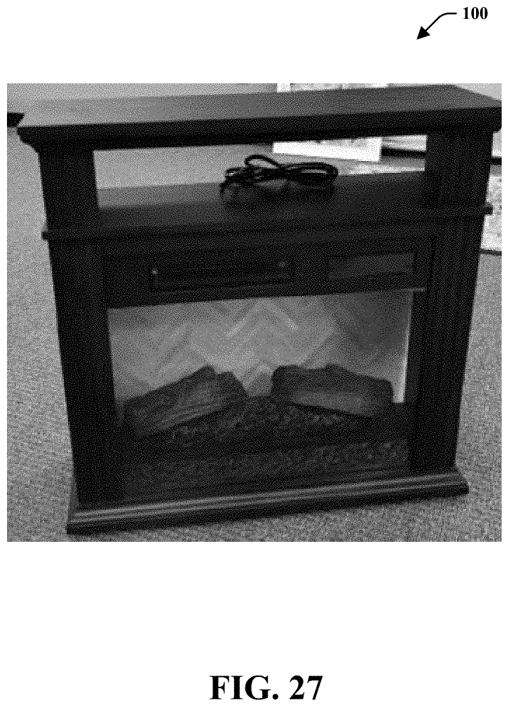

Optionally, the back panel 270 may be assembled to the insert housing 212 by bias bending the back panel (FIG. 24A and allowing opposing edges of the back panel to extend into slots along the first and second support walls 264, 268 (FIG. 24B. The back panel 270 could also be slide into place between the support walls 264, 268 and the base 266 and fastened into slots within the walls and or base with fasteners (FIGS. 24C and 24D). FIGS. 26 and 27 illustrate assembled versions of the electric fire place assembly 100 with back panels having different configurations.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An electric fireplace system comprising:
a modular fireplace insert comprising an insert housing that defines a cavity;
a simulated fuel source for simulating a fire display, the simulated fuel source includes a first housing that is configured to be positioned in the insert housing;
a heater assembly for generating heated air, the heater assembly including a second housing that is configured to be positioned in the insert housing; and
an interface device for controlling the simulated fuel source and the heater assembly.

2. The fireplace system of claim 1 wherein the insert housing is a freestanding device.

3. The fireplace system of claim 1 wherein the insert housing is configured to be inserted within a structure or incorporated with a structure wherein the structure includes at least one of a piece of furniture, cabinetry assembly, an opening in a wall of a building, a firebox of a traditional fireplace, and a frame.

4. The electric fireplace system of claim 1, wherein the simulated fuel source includes at least one of a set of artificial logs, artificial coal, an ember bed, an artificial grate, a background or screen, and a lighting display.

5. The electric fireplace system of claim 4, wherein the lighting display provides visual flame effects within the insert housing.

6. The electric fireplace system of claim 1, wherein the simulated fuel source includes a lighting display that provides visual flame effects within the insert housing, the lighting display includes a light source and a reflector that includes one or more rotating spindles having projections made of reflective material.

7. The electric fireplace system of claim 1, wherein the heater assembly includes an inlet, a heat source, and an outlet, wherein the inlet is for receiving ambient air, the heat source for warming the ambient air to heated air, and an outlet for exhausting the heated air out through a front side of the inlet housing, wherein the heat source is at least one of a radiant heat source, a forced air heat source, a fan forced convection source, an infrared heat source.

8. The electric fireplace system of claim 1, wherein the second housing is configured to be positioned above the first housing within the cavity of the insert housing.

9. The electric fireplace system of claim 1, wherein the insert housing is modular such that it is configured to be packaged in separate components and assembled by a user to define the cavity and to support the first housing, and the second housing within the cavity.

10. The electric fireplace system of claim 9, wherein the first housing and the second housing are configured to be packaged separately from the components of the insert housing and are configured to allow a user to assembly the first housing and the second housing within the cavity of the insert housing.

11. The electric fireplace system of claim 10, wherein the components of the insert housing include a first support wall, a second support wall, a base support, a support surface, and a backing panel wherein the first housing is configured to be attached to the base support and the second housing is configured to be attached to at least one of the first support wall, the second support wall, and the support surface above the first housing.

12. The electric fireplace system of claim 11, wherein the heater assembly includes an inlet, a heat source, and an outlet, wherein the inlet is for receiving ambient air, the heat source for warming the ambient air to heated air, and an outlet for exhausting the heated air out through a front side of the inlet housing.

13. The electric fireplace system of claim 11, wherein the heater assembly is configured to be removed from the insert housing while the simulated fuel source is positioned in the insert housing.

14. The electric fireplace system of claim 11, wherein the simulated fuel source is configured to be removed from the insert housing while the heater assembly is positioned in the insert housing.

15. An electric fireplace system comprising:
a modular fireplace insert comprising an insert housing that defines a cavity, the insert housing includes a first support wall, a second support wall, a base, a support surface, and a backing panel;
a simulated fuel source for simulating a fire display, the simulated fuel source includes a first housing that is configured to be positioned in the insert housing;
a heater assembly for generating warm air, the heater assembly including a second housing that is configured to be positioned in the insert housing; and
an interface device for controlling the simulated fuel source and the heater assembly,
wherein the first housing is configured to be attached to the base support and the second housing is configured to be attached to at least one of the first support wall, the second support wall, and the support surface above the first housing within the cavity.

16. The electric fireplace system of claim 15, wherein the insert housing is modular such that it is configured to be packaged in a deconstructed state wherein separate components including the first support wall, the second support wall, the base support, the support surface, and the back panel are configured to be assembled by a user prior to attaching the first housing, and the second housing in the insert housing.

17. The electric fireplace system of claim 16, wherein the first housing and the second housing are configured to be packaged separately from the components of the insert housing.

18. The electric fireplace system of claim 15, wherein the heater assembly includes an inlet, a heat source, and an outlet, wherein the inlet is for receiving ambient air, the heat source for warming the ambient air to heated air, and an outlet is configured to exhaust the heated air out through a front side of the inlet housing.

19. The fireplace system of claim 15 wherein the insert housing is configured to be inserted within a structure or incorporated with a structure wherein the structure includes at least one of a piece of furniture, cabinetry assembly, an opening in a wall of a building, a firebox of a traditional fireplace, and a frame.
